(19) United States
(12) Patent Application Publication
(10) Pub. No.: US 2026/0158394 A1
(43) Pub. Date: Jun. 11, 2026

(54) MODULAR GAME MAKER MODEL

(71) Applicant: Lemon Inc., Grand Cayman (KY)

(72) Inventors: Felicity Wing Tin Yick, Los Angeles, CA (US); Blake Garrett Fuselier, Los Angeles, CA (US); Jie Meng, Los Angeles, CA (US); Jagminder Singh Shergill, Los Angeles, CA (US); Runjia Tian, Los Angeles, CA (US); Priyeshkumar Wani, Los Angeles, CA (US); Runze Zhang, Los Angeles, CA (US)

(21) Appl. No.: 18/976,195

(22) Filed: Dec. 10, 2024

(51) Int. Cl. A63F 13/67

(52) U.S. Cl. CPC A63F 13/67

(57) ABSTRACT

A computing system receives a user input, determines a game type based on the user input, generates a content configuration based on the user input and the game type, generates content commands based on the content configuration, and generates the game application by executing the content commands to select and interconnect modular subgraphs from a library of a plurality of subgraphs via visual scripting logic. The content configuration can be generated by generating one or more prompts, inputting the one or more prompts into a language model to generate responses, and consolidating the responses from the language model into the content configuration.

### BACKGROUND

The development of game applications is a complex and resource-intensive process that involves multiple phases, including concept creation, design, programming, and testing. Traditionally, most game development has been limited to professional game developers due to the specialized skills and significant time investment required. As the demand for engaging and innovative gaming content has increased, the industry has sought more efficient and automated methods that make game development more accessible to casual users.

In recent years, advancements in machine learning and natural language processing (NLP) have opened new possibilities for automating creative and technical tasks across various industries. Despite these advancements, the process of designing and building game applications has yet to fully harness the capabilities of language models.

### SUMMARY

In view of the above issues, a computing system is provided for generating a game application. The computing system includes processing circuitry and memory storing instructions that, when executed, cause the processing circuitry to receive a user input, determine a game type based on the user input, generate a content configuration based on the user input and the game type, generate content commands based on the content configuration, and generate the game application by executing the content commands to select and interconnect a set of modular subgraphs from a library of a plurality of subgraphs via visual scripting logic. The content configuration can be generated by generating one or more prompts, inputting the one or more prompts into a language model to generate responses, and consolidating the responses from the language model into the content configuration.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a schematic view of a computing system according to an example of the present disclosure.

FIG. 2 illustrates a schematic view of the operations of the trained machine learning modular game maker model of the computing system of FIG. 1.

FIG. 3 illustrates a detailed schematic of an example of the inputs and outputs of the language model of FIGS. 1 and 2.

FIG. 4 illustrates a detailed schematic of an example of one prompt and one response among the inputs and outputs of the language model of FIG. 3.

FIG. 5 illustrates a schematic view of a content configuration generated by the content configuration generator of FIGS. 1 and 2.

FIG. 6 illustrates an exemplary schematic view of the subgraphs that may be interconnected by the game builder of FIGS. 1 and 2 to generate a game application.

FIG. 7 illustrates a detailed schematic of an example of how the subgraphs of FIG. 6 may be interconnected to generate a game application.

FIG. 8 illustrates an example of a user input that may be processed by the trained machine learning modular game maker model of FIGS. 1 and 2 to generate a natural language response and a game application.

FIG. 9 illustrates an example of a subsequent user input that may be processed by the trained machine learning modular game maker model of FIGS. 1 and 2 to modify the game application generated in FIG. 8.

FIG. 10 is a flow chart of a method for generating a game application according to an example embodiment of the present disclosure.

FIG. 11 shows an example computing environment of the present disclosure in which the computing system of FIG. 1 may be enacted.

### DETAILED DESCRIPTION

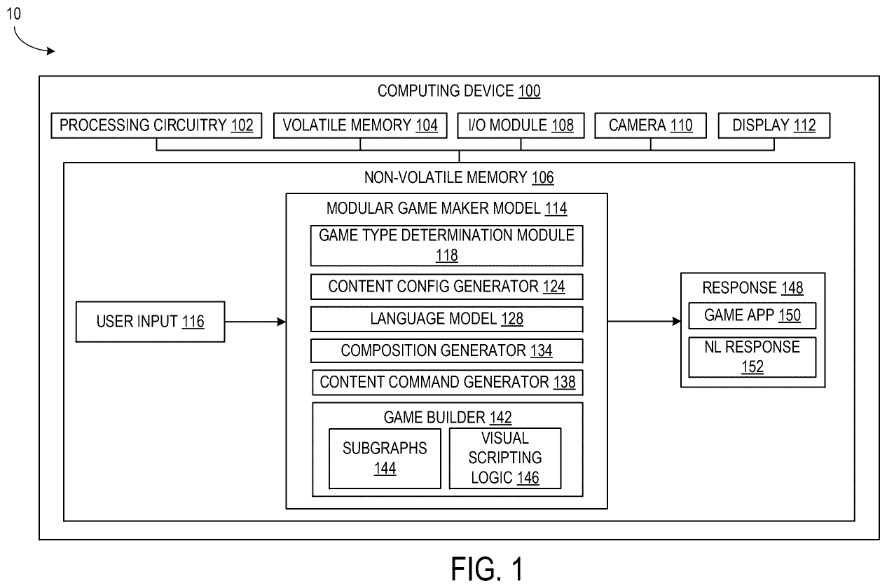

FIG. 1 shows a schematic view of a first example computing system 10 including a computing device 100 for generating a game application 150 using a trained machine learning modular game maker model 114. The computing device 100 includes processing circuitry 102 (e.g., central processing units, or “CPUs”), volatile memory 104, non-volatile memory 106, an input/output (I/O) module 108, a camera 110, and a display 112. The different components are operatively coupled to one another. The non-volatile memory 106 stores instructions to execute the trained machine learning modular game maker model 114 which is configured to receive a user input 116 and generate a response 148 including the game application 150 and a natural language response 152 based on the user input 116.

The trained machine learning modular game maker model 114 includes a game type determination module 118 configured to determine a game type based on the user input 116, a content configuration generator 124 configured to generate a content configuration based on the user input and the game type, a language model 128 configured to receive one or more prompts from the content configuration generator 124 to generate one or more responses that are consolidated by the content configuration generator 124 to generate a content configuration, a composition generator 134 configured to generate a composition object based on the content configuration, a content command generator 138 configured to generate content commands based on the content configuration, and a game builder 142 configured to execute the content commands to generate the game application 150 by selecting and interconnecting a set of subgraphs 144 from a library of a plurality of subgraphs 144 in accordance with visual scripting logic 146. The visual scripting logic can be implemented in a graphical user interface of a visual scripting program. The subgraphs 144 are modular script graphs that each accomplish independent functions, but through the selection and interconnection, can be nested within a main script graph of the game application, to thereby create visual scripting logic to implement the main script graph (including its subgraphs) for the entire game application. The visual scripting logic can be interpreted by a script interpreter. The script interpreter can interpret the visual scripting logic in real time, to enable a user to try out and modify the game that has just been created, as described below.

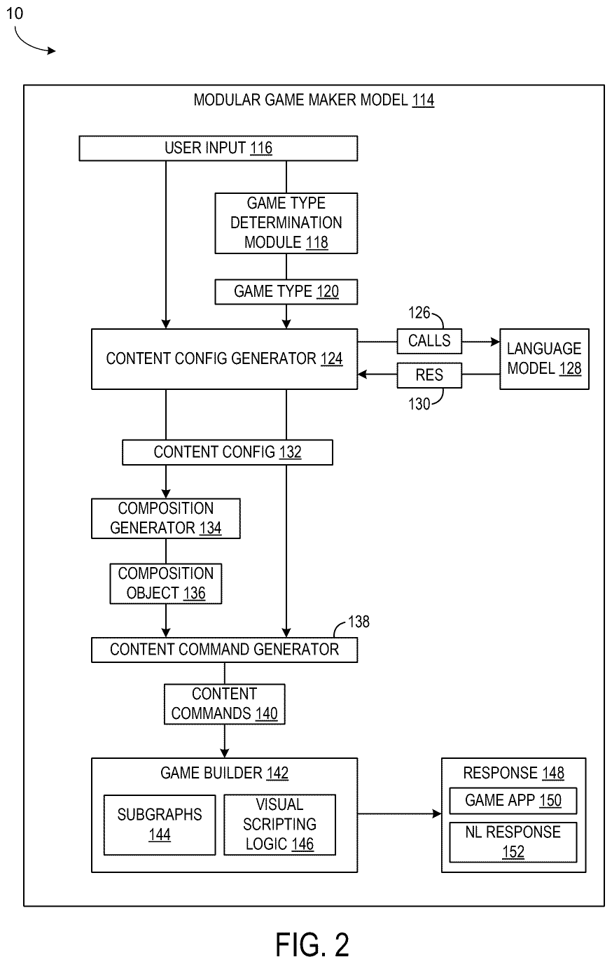

Referring to FIG. 2, the operations of the modular game maker model 114 are described in further detail. The modular game maker model 114 uses a modular approach to the automated generation of a game application 150 based on user input 116, leveraging a language model 128 to interpret and guide the game creation process. The modular game maker model 114 receives user input 116, which may mention various aspects of the desired game, such as game type, themes, player objectives, character dynamics, or overall game mechanics. Responsive to receiving the user input 116, the game type determination module 118 analyzes the user input 116 to determine a corresponding game type 120. The game type determination module 118 may be a language model, for example.

Possible game types 120 generated by the system may include a variety of genres and objectives. For example, a survival game focuses on the player's ability to stay alive for as long as possible by overcoming threats, managing resources, and adapting to changing environments. Another game type is the A-to-B game, where the player's goal is to move a character from point A to point B, often navigating obstacles, solving puzzles, or avoiding enemies along the way.

The identified game type 120 and the original user input 116 are fed into the content configuration generator 124, which interprets the user input 116 into prompts 126 or calls that guide subsequent content creation through the language model 128. The calls 126 are inputted into the language model 128 to generate responses 130 that are subsequently consolidated into a content configuration 132. These prompts 126 may include questions and requests for detailed input, such as: “Determine the win conditions for the game,” “Describe the main style and aesthetic of the game,” and “Identify and detail the primary entities and their roles within the game”. The language model 128 processes these prompts 126 and delivers responses 130, which are then consolidated by the content configuration generator 124 into a content configuration 132. The content configuration 132 is formatted to encapsulate all relevant data, which may include game mechanic types, definitions of win conditions, definitions of loss conditions, definitions of main characters (main entities), and definition of enemies (secondary entities). This structured format ensures that every piece of information for defining the game application 150 is captured to facilitate further processing and eventual game generation. The content configuration 132 may be formatted as a JSON file, for example.

The content configuration 132 may be subsequently provided to a composition generator 134, which transforms the content configuration into a composition object 136, which defines the layout, arrangement, and spatial configuration of entities within the game scenes. The composition object specifies the visual and structural design of the game environment, determining how different game elements interact and appear to the player.

To translate the structured data into executable commands, the content command generator 138 receives both the content configuration 132 and the composition object 136 to generate content commands 140, which dictate the instantiation of game entities, user interfaces, visual scripting nodes, parameters, and connections required for the construction of the game application 150. These commands may also include directives for image generation based on the composition object 136, such as defining textures, colors, and visual details of game elements.

The final stage involves the game builder 142, which executes the content commands 140 to construct the final game application 150. This process is facilitated by visual scripting logic 146, which organizes and connects subgraphs 144, which are modular elements that encompass game triggers, player movement controllers, animation subgraphs, collision managers, and more. The arrangement of these modular subgraphs 144 streamlines the development process, enabling rapid assembly and configuration of complex game mechanics. The final output or response 148 includes not only the fully developed game application 150 but also a natural language response 152, which provides a descriptive summary or relevant guidance regarding the generated game application 150, offering the user a comprehensive overview of their creation.

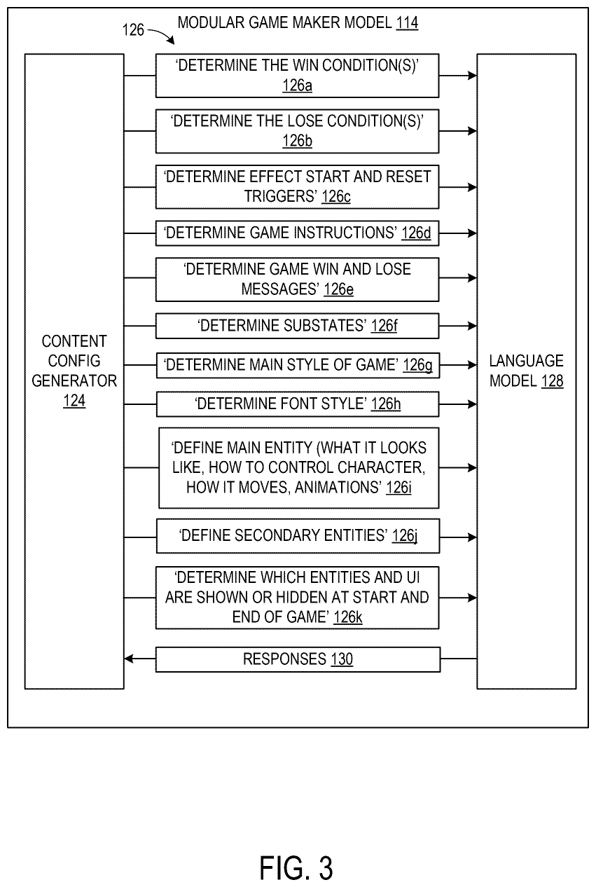

FIG. 3 illustrates the interaction between the content configuration generator 124 and the language model 128, highlighting the prompts 126 that guide the game generation process. The content configuration generator 124 initiates a series of structured calls 126 or prompts to the language model 128, eliciting detailed responses 130 that form the basis for various aspects of the structure and behavior of the game application 150. These prompts 126 serve as high-level instructions and queries, enabling the content configuration generator 124 to gather details about the design and mechanics of the game application 150.

The prompts 126 include requests such as “determine the win condition(s)” 126a and “determine the lose condition(s)” 126b, which guide the language model in defining the specific criteria for victory or failure within the game. For example, a survival game may require a player to endure a certain amount of time, while a puzzle game may involve solving all presented challenges to win. Additional prompts include “determine the effect start and reset triggers” 126c, aimed at specifying events that initiate or reset gameplay mechanics, and “determine game instructions” 126d, which generate clear directions to guide players on how to play the game.

To enhance the immersive experience, the prompts 126 also encompass elements such as “determine game win and lose messages” 126e, “determine substates” 126f, “determine main style of game” 126g, and “determine font style” 126h. These prompts 126e-g help shape the narrative, progression mechanics, and visual aesthetics of the game. The content configuration generator 124 further makes calls 126 to the language model 128 for the “definition of the main entity” 126i, including what it looks like, how it is controlled, how it moves, and its animations, as well as the “definition of secondary entities” 126j that populate the game world, such as enemies. A prompt 126k also asks which entities and user interfaces are shown or hidden at the start and end of the game, providing dynamic control over visual presentation and interactivity.

The responses 130 from the language model 128 to these prompts 126 are used to populate and structure the content configuration 132, providing a robust framework for subsequent processing stages, including composition generation, command generation, and the final game assembly. This approach ensures that each element of the game is thoughtfully defined, cohesive, and tailored to the user input 116, streamlining the overall game creation process.

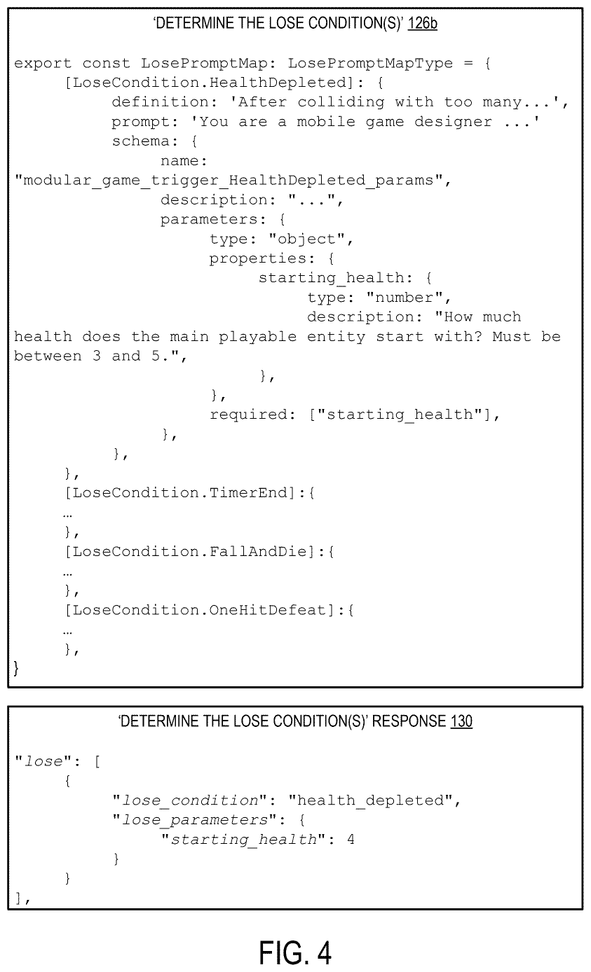

FIG. 4 illustrates an example prompt 126b generated by the content configuration generator 124 and inputted into the language model 128 to determine specific lose conditions for a game application 150. The prompt 126b is formatted in JSON and defines a structure for creating different types of lose conditions within the game application 150. This example focuses on a lose condition where the player loses upon health depletion, among other potential conditions, such as a timer running out, falling and dying, or being defeated by a single hit.

The JSON structure for the prompt 126b includes a mapping called ‘LosePromptMap’ that outlines the main types of lose conditions and their associated properties. For the HealthDepleted condition, the prompt 126b includes a natural language definition, which states, “After colliding with too many enemies, the player loses when the number of lives or health has dropped to zero. Choose health_depleted if the user specifically asks for the player to have health or multiple lives.” This detailed description informs the language model 128 of the contextual meaning and relevance of the health-based lose condition within the game.

The body of prompt 126b further elaborates on its purpose through a scenario where the language model acts as a “mobile game designer” working with a client to define game mechanics. It reads: “You are a mobile game designer working with a client to ideate on an exciting new 2D game idea. How you lose the game is by running out of health. I will give you the <client's game request>, and you have to decide on the following details about this win condition. Follow the steps below to determine the <starting health>: 1-Analyse the <client's game request>. 2-Determine the <starting health> the main playable entity has during the game. The starting health must be between 3 and 5, and is the initial number of lives of the player. 3-Output <starting health> as a JSON. Provide your output in json format with the keys: “starting_health”: {“starting_health”: <insert the starting health here. Must be a number between 3 and 5.>,} Here is the <client's game request>: {user_input} Here is the description of the general game: {game_description} Here are the restrictions of the game. You must adhere to it: {restrictions}.”

This structured prompt 126b guides the language model 128 to analyze the user input 116 and determine a valid starting health value for the main playable entity, adhering to predefined constraints such as ensuring the starting health is a number between 3 and 5. The response 130 from the language model to this prompt is a JSON output specifying the determined starting health value, for example, ‘“starting_health”: 4’. Accordingly, the language model 128 can make specific game design decisions that align with the parameters and requirements outlined in the prompt 126b.

The prompts for the other lose conditions, such as the timer running out (LoserCondition.TimerEnd), falling and dying (LoseCondition.FallAndDie), and one-hit defeat (LoseCondition.OneHitDefeat), have been replaced with ellipses in FIG. 4 for brevity. However, it will be appreciated that they follow a similar structure to the HealthDepleted lose condition. Each of these prompts includes a detailed natural language definition, specific instructions, and necessary parameters formatted in JSON to guide the responses 130 of the language model 128.

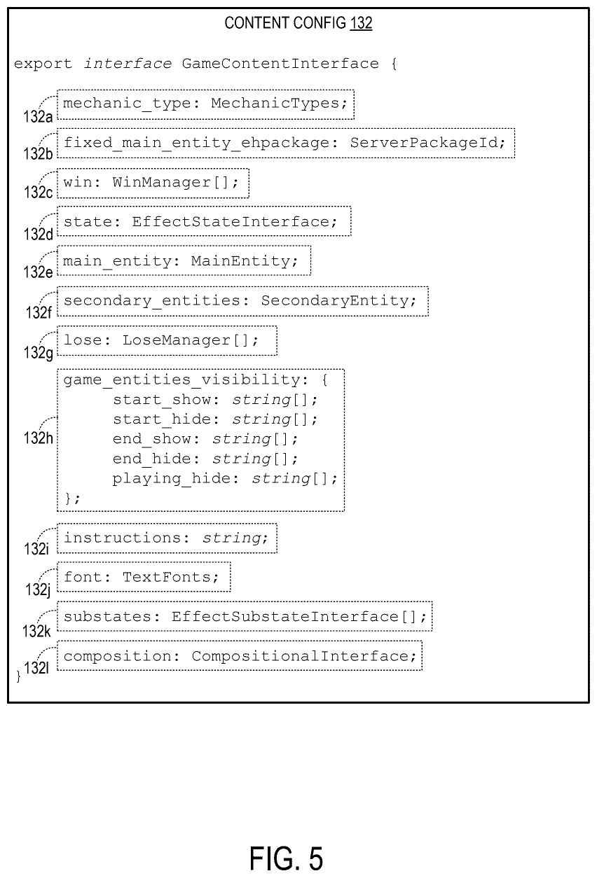

FIG. 5 provides a detailed view of the structure of an exemplary content configuration 132, which serves as a comprehensive blueprint for the generation of a game application based on user input. The content configuration 132 is formatted to encapsulate all necessary elements and properties that define the mechanics, entities, rules, and visual presentation of the game 150. Each element within the content configuration 132 plays a role in guiding subsequent stages of game creation, ensuring consistency and coherence across the generated game application 150.

The ‘mechanic_type’ 132a element identifies the type of game being generated, such as an A-to-B game or a survival game, based on the determined game type 120.

The ‘fixed_main_entity_ehpackage’ 132b includes the fixed main entity packages, defining parameters and preconfigured elements that pertain to the primary main entity within the game. The ‘main_entity’ element 132e provides a detailed description of the main entity, including its appearance, control mechanisms, movement patterns, and animations. The ‘secondary_entities’ element 132f describes secondary entities that populate the game world, such as enemies, allies, or neutral characters. The ‘game_entities_visibility’ element 132h specifies which entities and user interfaces are shown or hidden at different stages of the game. This includes defining visibility states at the start and end of the game, as well as during gameplay, allowing for dynamic transitions and user interface control.

The ‘win’ element 132c defines the specific criteria for victory within the game. This element outlines the conditions that must be met for the player to succeed, which could include completing objectives or surviving for a set duration. The ‘lose’ element 132g defines the criteria for failure within the game, outlining the conditions under which the player will lose, such as depleting health, running out of time, or being defeated by a specific challenge.

The ‘state’ element 132d encompasses properties related to effect start and reset triggers, as well as events that initiate or reset gameplay mechanics. Additionally, this element may include game win and lose messages, the main style of the game, and other dynamic states that influence game behavior and progression. The ‘substates’ element 132k outlines the game's substates, describing additional states or modes that the game can enter, such as different levels, phases, or gameplay modes.

The ‘instructions’ element 132i provides game instructions, offering players guidance on how to play and succeed within the game environment. The ‘font’ element 132j defines the font style used throughout the game, ensuring visual consistency and alignment with the game's overall aesthetic.

Finally, the ‘composition’ element 132l may include the composition object 136, which may optionally be appended to the content configuration 132. This element defines the layout, arrangement, and spatial configuration of entities within the game scenes, contributing to the overall look and feel of the game. Accordingly, the content configuration ensures that every aspect of the game 150 is aligned with user input 116 and the desired gameplay experience.

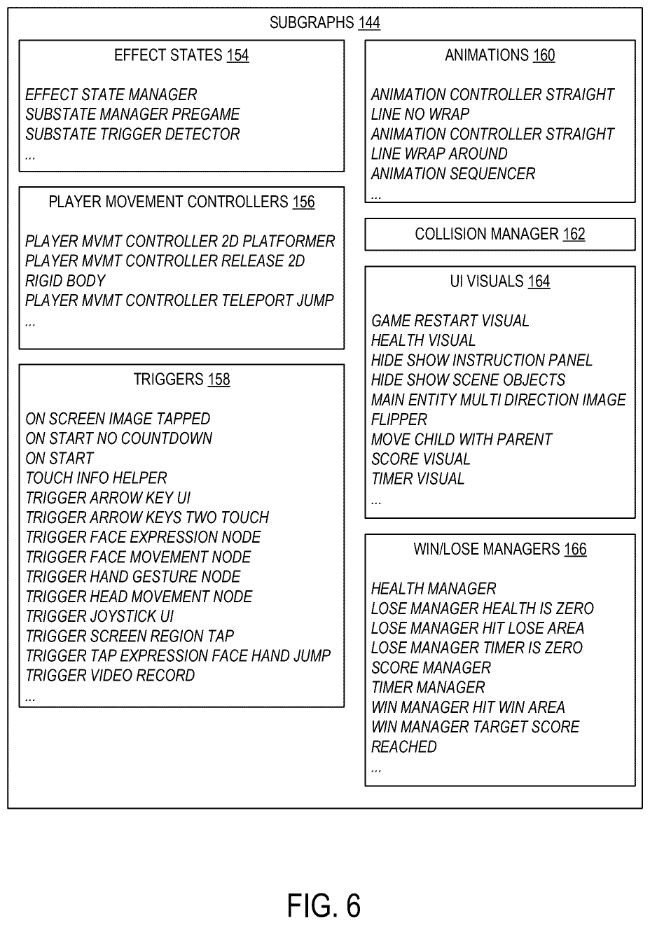

FIG. 6 illustrates various examples of subgraphs 144 that may be used by the game builder 142 to assemble the final game application 150. The final game application 150 encompasses a graph data structure defining interoperable elements of the game. Subgraphs 144 are compiled together to produce the graph data structure for the game. Subgraphs 144 represent modular elements, nodes, or components that define specific functions, behaviors, controls, and/or interactions within the environment of the game application 150. By organizing and connecting these subgraphs 144, the game builder 142 may efficiently construct complex game mechanics and interactions in a modular and scalable manner. Connections between subgraphs 144 may be established based on events, such as collisions, and include conditions, loops, or branches, enabling complex behaviors through conditional paths. The subgraphs 144 may pass data, including state information, to each other to enable complex game mechanics. The subgraphs 144 may include effect states 154, player movement controllers 156, triggers 158, animations 160, collision manager 162, user interface (UI) visuals 164, and win/lose managers 166.

The effect states 154 are responsible for managing the dynamic states and transitions within the game. Examples may include the “effect state manager,” which oversees state changes and their triggers; “substate manager pregame,” which manages any states or conditions that exist before gameplay begins; and “substate trigger detector,” which monitors and activates specific substates during gameplay. These components enable flexible control over game phases and transitions, enhancing the overall gameplay experience.

The triggers 158 define the events and interactions that drive game behavior based on user actions or other conditions. Examples include “on screen image tapped,” which triggers a response when an image on the screen is tapped, and “on start no countdown,” which initiates an action at the start of the game without a countdown. Other examples include “trigger arrow key UI,” which responds to arrow key inputs; “trigger face expression node” and “trigger face movement node,” which detect and respond to face expressions or movements; “trigger joystick UI,” for joystick interactions; and “trigger video record,” which activates video recording. These triggers 158 offer a diverse range of input options and interactions, creating a highly engaging and responsive game environment.

The animations 160 control the movement and visual changes of game elements. Examples include “animation controller straight line no wrap,” which manages straight-line animations without wrapping around; “animation controller straight line wrap around,” which allows wrapping; and “animation sequencer,” which controls the sequence of animations. These animations 160 provide fluid and visually appealing animations that enhance the aesthetic and interactive quality of the game.

The UI visuals 164 manage the display and interaction of user interface elements within the game. Examples include “game restart visual,” which controls visuals related to restarting the game; “health visual,” which displays health-related information; “hide show instruction panel” and “hide show scene objects,” which manage the visibility of specific UI elements or scene objects. Other examples, such as “main entity multi direction image flipper” and “timer visual,” further enhance user engagement by providing real-time feedback and visual cues.

The win/lose managers 166 define the criteria for victory and defeat within the game. Examples include the “health manager,” which tracks and updates player health; “lose manager health is zero,” which triggers a lose condition when health reaches zero; and “lose manager timer is zero,” which triggers a loss when a timer runs out. Additional examples, such as “score manager” and “win manager hit win area,” handle score-based wins and specific game milestones, respectively. These managers 166 ensure that the game's goals, rewards, and consequences are clearly defined and executed.

By leveraging these subgraphs 144, the game builder 142 is able to modularly assemble and manage complex game logic, providing a structured and scalable approach to game creation.

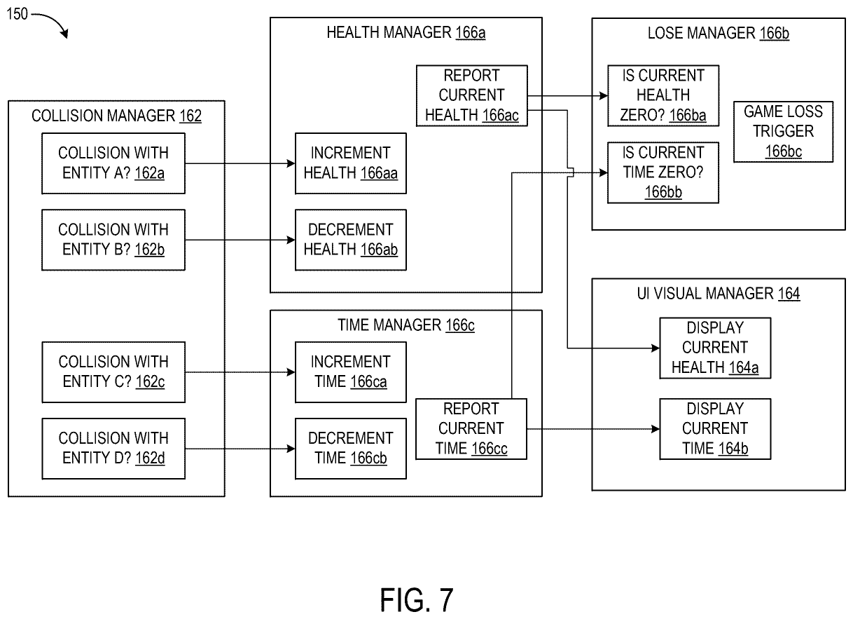

FIG. 7 illustrates an example of how the various subgraphs 144 may be interconnected via the visual scripting logic 146 of the game builder 142 to build the final game application 150. In this example, the collision manager 162, health manager 166a, time manager 166c, lose manager 166b, and UI visual manager 164 are connected together to automate complex game interactions and behaviors. The inputs and outputs of the subgraphs 144 are formatted to be compatible with each other, thereby enabling the interconnections between the subgraphs 144. The interconnected subgraphs 144 are nested within (i.e., form) a main graph of the game application.

The collision manager 162 serves as a central control mechanism for detecting collision interactions between the main game entity and various other entities A, B, C, and D in this example. The collision manager 162 executes a first logic 162a of determining whether the main entity has collided with entity A. Responsive to determining that the main entity has collided with entity A, the health manager 166a executes the health incrementing logic 166aa to increment the health of the main entity.

Further, the collision manager 162 executes a second logic 162b of determining whether the main entity has collided with entity B. Responsive to determining that the main entity has collided with entity B, the health manager 166a executes the health decrementing logic 166ab to decrement the health of the main entity.

Further, the collision manager 162 executes a third logic 162c of determining whether the main entity has collided with entity C. Responsive to determining that the main entity has collided with entity C, the time manager 166c executes the time incrementing logic 166ca to increment the time of the main entity.

Further, the collision manager 162 executes a fourth logic 162d of determining whether the main entity has collided with entity D. Responsive to determining that the main entity has collided with entity D, the time manager 166c executes the time decrementing logic 166cb to decrement the time of the main entity.

The health manager 166a executes health reporting logic 166ac to report the current health to the lose manager 166b and the UI visual manager 164. The lose manager 166b executes health evaluation logic 166ba to determine whether the current health is zero. Upon determining that the current health is zero, the game loss trigger 166bc is initiated, indicating that the game is over due to the loss of health. Meanwhile, the UI visual manager 164 executes display current health logic 164a to display the current health on the user interface.

The time manager 166c executes time reporting logic 166cc to report the current time to the lose manager 166b and the UI visual manager 164. The lose manager 166b executes time evaluation logic 166bb to determine whether the current time is zero. Upon determining that the current time is zero, the game loss trigger 166bc is initiated, indicating that the game is over due to the expiration of time. Meanwhile, the UI visual manager 164 executes display current time logic 164b to display the current time on the user interface.

By interconnecting these various subgraphs 144 through visual scripting logic, the scripting of complex game interactions and behaviors may be greatly streamlined and automated, thereby cutting down on the time and expertise required to code such complex game logic.

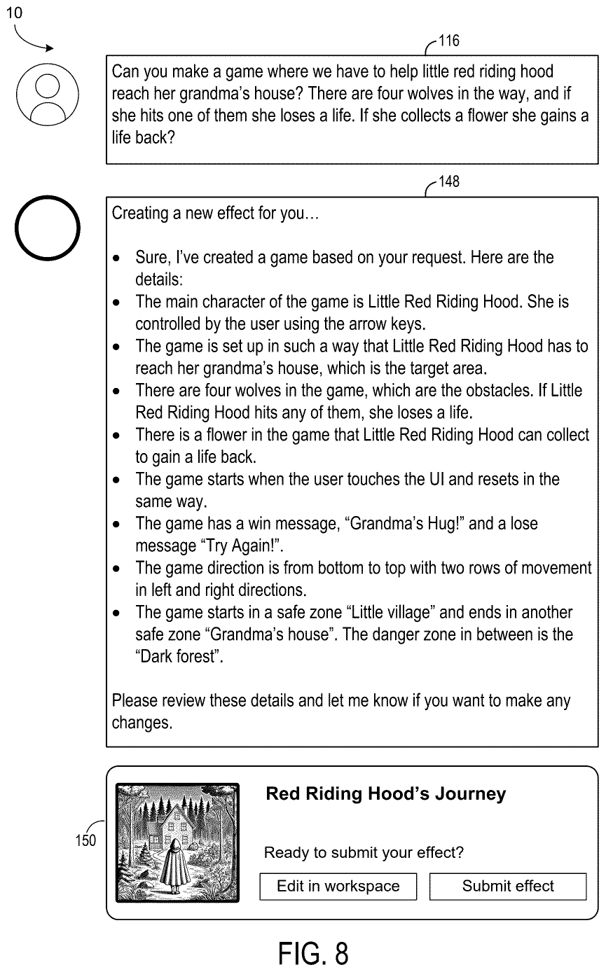

FIG. 8 illustrates an example scenario in which a user inputs a user input 116: “Can you make a game where we have to help Little Red Riding Hood reach her grandma's house? There are four wolves in the way, and if she hits one of them she loses a life. If she collects a flower, she gains a life back.” The modular game maker model 114 processes this user input 116 to generate a tailored game application 150.

Upon receiving the user input 116, the game type determination module 118 analyzes the request and identifies that the appropriate game type 120 is an A-to-B game, in which the main entity must be guided from a starting point to a designated end point.

The content configuration generator 124 interacts with the language model 128 and generates a content configuration 132 identifying the main entity and secondary entities. In this case, the main entity is Little Red Riding Hood, whose goal is to traverse from her starting position to her grandma's house, the target area. The secondary entities are defined as wolves and flowers, reflecting the user's description of obstacles and helpful items, respectively. The behavior of these secondary entities is specified through collision events. A collision with a wolf decrements the main entity's health by one, as defined by the health decrementing logic. Conversely, collecting a flower increments Little Red Riding Hood's health by one, as defined by the health incrementing logic, providing a way for the player to regain lost health. This game logic is structured into the content configuration 132, guiding the game's behavior and interactions.

The game builder 142 then assembles the game application 150 according to the game mechanics and specifications defined in the content configuration 132. The resulting game features are conveyed to the user through a natural language response 148 that outlines the key details of the generated game. In this example, the natural language response 148 specifies that the main character of the game is Little Red Riding Hood. She is controlled by the user using the arrow keys. The game is set up in such a way that Little Red Riding Hood has to reach her grandma's house, which is the target area. There are four wolves in the game, which are the obstacles. If Little Red Riding Hood hits any of them, she loses a life. There is a flower in the game that Little Red Riding Hood can collect to gain a life back. The game starts when the user touches the UI and resets in the same way. The game has a win message, “Grandma's Hug!” and a lose message, “Try Again!” The game direction is from bottom to top with two rows of movement in left and right directions. The game starts in a safe zone, “Little village,” and ends in another safe zone, “Grandma's house.” The danger zone in between is the “Dark forest.”

The response 148 also includes a link to the game application 150 with prompts asking the user whether the ‘effect’ (the generated game) is ready to be submitted or edited further in the workspace. In other words, the response 148 invites a subsequent user input to modify the game application 150.

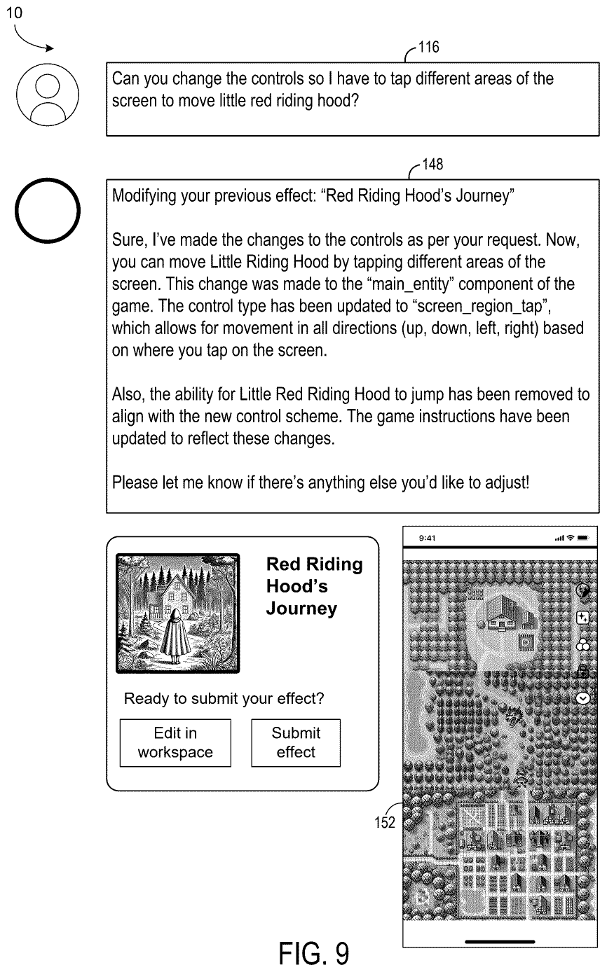

FIG. 9 illustrates an example scenario in which, responsive to receiving the response inviting a subsequent user input to modify the game application 150, the user prompts the game builder 142 to change the game application 150 that was initially generated in FIG. 8. The user provides the input 116: “Can you change the controls so I have to tap different areas of the screen to move little red riding hood?”

In response, the game builder 142 modifies the game application 150 so that the user can move Little Riding Hood by tapping different areas of the screen. The natural language response 148 indicates how the change was made. In this example, the change was made to the main entity component of the game, and the control type was updated to “screen_region_tap” to allow for movement in all directions (up, down, left, right) based on where the user taps on the screen. The ability for Little Red Riding Hood to jump was removed to align with the new control scheme, and game instructions were also updated.

The response 148 also includes a link to the game application 150 with prompts asking the user whether the ‘effect’ (the modification to the generated game) is ready to be submitted or edited further in the workspace. A preview of the final game application 150 is also shown in the response 148.

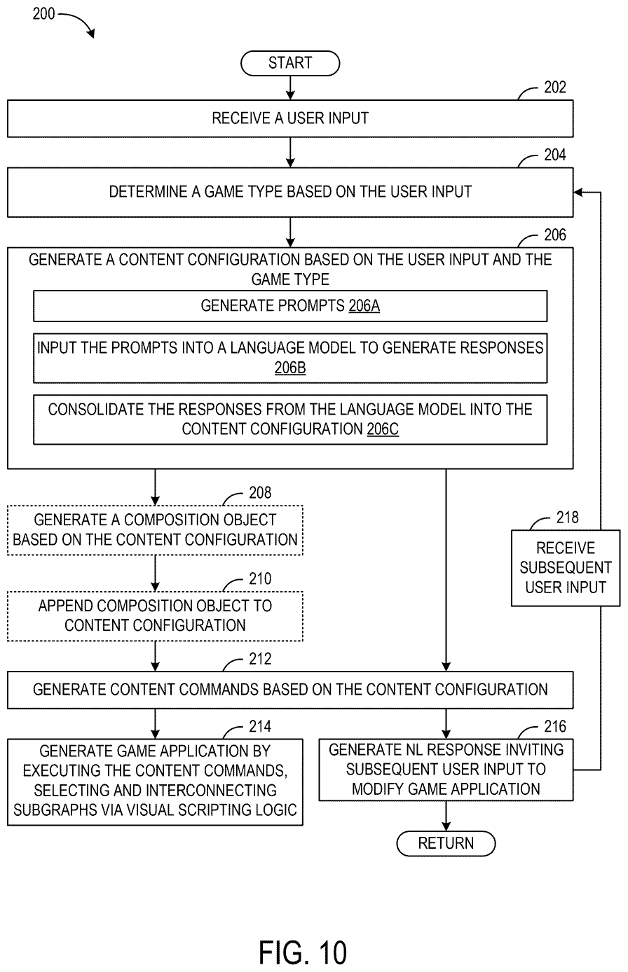

FIG. 10 shows a process flow diagram of an example method 200 for generating a game application. The example method 200 may be executed by the processing circuitry 102 and memory 104 of the computing system 10 of FIG. 1. The example method 200 includes, at step 202, receiving a user input, and at step 204, determining a game type based on the user input. At step 206, the method 200 includes generating a content configuration based on the user input and the game type. Step 206 may include step 206A of generating prompts, step 206B of inputting the prompts into a language model to generate responses, and step 206C of consolidating the responses from the language model into the content configuration.

The method 200 may also include step 208 of generating a composition object based on the content configuration, and step 210 of appending the composition object to the content configuration. At step 212, the method 200 includes generating content commands based on the content configuration. At step 214, the method 200 includes generating the game application by executing the content commands by interconnecting subgraphs via visual scripting logic, and at step 216, generating a natural language response inviting a subsequent user input to modify the game application. When, at step 218, a subsequent user input is received, the method 200 proceeds to step 204 of determining a game type based on the subsequent user input.

As described throughout herein, by leveraging language models to streamline the game development process, game creation may be democratized for greater accessibility to casual users. The above-described system and method bridge the gap between human creativity and machine-driven automation in game development, offering a scalable, adaptive approach that interprets user inputs, translates them into logical structures, and generates comprehensive game applications with minimal manual intervention, thereby empowering a wider range of users to bring their creative visions to life.

The modular approach to game generation using subgraphs, guided by the integration of a language model, significantly enhances the efficiency and accessibility of game development. By automating content generation, composition structuring, and command synthesis, users with varying levels of expertise may be empowered to create complex, customized game applications with minimal manual effort.

In some embodiments, the methods and processes described herein may be tied to a computing system of one or more computing devices. In particular, such methods and processes may be implemented as a computer-application program or service, an Application Program Interface (API), a library, and/or other computer-program product. In some embodiments, the methods and processes described herein may be tied to a computing system of one or more computing devices. In particular, such methods and processes may be implemented as a computer-application program or service, an API, a library, and/or other computer-program product.

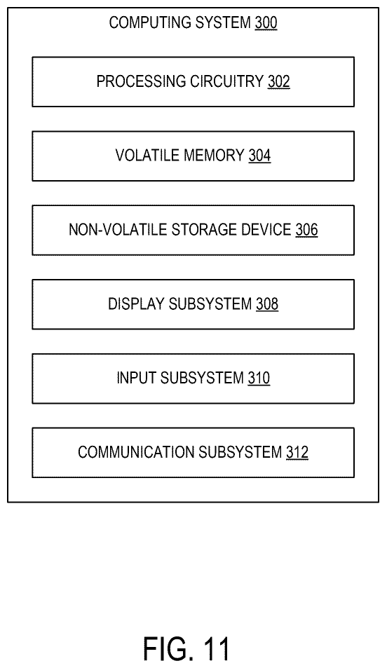

FIG. 11 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 11.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry 302 to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system for generating a game application, the computing system comprising processing circuitry and memory storing a modular game maker model that, when executed, causes the processing circuitry to receive a user input, determine a game type based on the user input, generate a content configuration based on the user input and the game type, generate content commands based on the content configuration, and generate the game application by executing the content commands to select and interconnect a set of modular subgraphs from a library of a plurality of modular subgraphs via visual scripting logic. In this aspect, additionally or alternatively, the content configuration may be generated by generating one or more prompts, inputting the one or more prompts into a language model to generate one or more responses, and consolidating the one or more responses from the language model into the content configuration. In this aspect, additionally or alternatively, the content configuration may define at least one of game type, win conditions, loss conditions, main entities, or secondary entities. In this aspect, additionally or alternatively, the content configuration may be formatted as a JSON file. In this aspect, additionally or alternatively, each modular subgraph may represent a function or behavior within the game application. In this aspect, additionally or alternatively, the modular subgraphs may include at least one of an effect state, a player movement controller, a trigger, an animation, a collision manager, a user interface (UI) visual, a win manager, or a lose manager. In this aspect, additionally or alternatively, the processing circuitry may be configured to further generate a composition object based on the content configuration, and generate content commands based on the content configuration and the composition object, the composition object defining a layout of entities within game scenes of the game application. In this aspect, additionally or alternatively, the composition object may be appended to the content configuration. In this aspect, additionally or alternatively, the game type may be one of at least a survival game or an A-to-B game. In this aspect, additionally or alternatively, the processing circuitry may be configured to further generate a natural language response inviting a subsequent user input to modify the game application.

Another aspect provides a computing method for generating a game application via a modular game maker model, the computing method comprising receiving a user input, determining a game type based on the user input, generating a content configuration based on the user input and the game type, generating content commands based on the content configuration, and generating the game application by executing the content commands to select and interconnect modular a set of subgraphs from a library of a plurality of subgraphs via visual scripting logic. In this aspect, additionally or alternatively, the content configuration may be generated by generating one or more prompts, inputting the one or more prompts into a language model to generate one or more responses, and consolidating the one or more responses from the language model into the content configuration. In this aspect, additionally or alternatively, the content configuration may define at least one of game type, win conditions, loss conditions, main entities, or secondary entities. In this aspect, additionally or alternatively, each modular subgraph may represent a function or behavior within the game application. In this aspect, additionally or alternatively, the subgraphs may include at least one of an effect state, a player movement controller, a trigger, an animation, a collision manager, a user interface (UI) visual, a win manager, or a lose manager. In this aspect, additionally or alternatively, the computing method may further comprise generating a composition object based on the content configuration, and generating content commands based on the content configuration and the composition object, the composition object defining a layout of entities within game scenes of the game application. In this aspect, additionally or alternatively, the composition object may be appended to the content configuration. In this aspect, additionally or alternatively, the game type may be one of at least a survival game or an A-to-B game. In this aspect, additionally or alternatively, the computing method may further comprise generating a natural language response inviting a subsequent user input to modify the game application.

Another aspect provides a computing system for generating a game application, the computing system comprising processing circuitry and memory storing instructions that, when executed, cause the processing circuitry to receive a user input, generate content commands based on the user, and execute the content commands to generate the game application by selecting and interconnecting a set of subgraphs from a library of a plurality of subgraphs via visual scripting logic, wherein the subgraphs include at least one of an effect state, a player movement controller, a trigger, an animation, a collision manager, a UI visual, a win manager, or a lose manager.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

It will be appreciated that “and/or” as used herein refers to the logical disjunction operation, and thus A and/or B has the following truth table.

| A | B | A and/or B |
|---|---|---|
| T | T | T |
| T | F | T |
| F | T | T |
| F | F | F |

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for generating a game application, the computing system comprising:
processing circuitry and memory storing a modular game maker model that, when executed, causes the processing circuitry to:
receive a user input;
determine a game type based on the user input;
generate a content configuration based on the user input and the game type;
generate content commands based on the content configuration; and
generate the game application by executing the content commands to select and interconnect a set of modular subgraphs from a library of a plurality of modular subgraphs via visual scripting logic.

2. The computing system of claim 1, wherein the content configuration is generated by generating one or more prompts, inputting the one or more prompts into a language model to generate one or more responses, and consolidating the one or more responses from the language model into the content configuration.

3. The computing system of claim 1, wherein the content configuration defines at least one of game type, win conditions, loss conditions, main entities, or secondary entities.

4. The computing system of claim 1, wherein the content configuration is formatted as a JSON file.

5. The computing system of claim 1, wherein each modular subgraph represents a function or behavior within the game application.

6. The computing system of claim 5, wherein the modular subgraphs include at least one of an effect state, a player movement controller, a trigger, an animation, a collision manager, a user interface (UI) visual, a win manager, or a lose manager.

7. The computing system of claim 1, wherein the processing circuitry is configured to further:
generate a composition object based on the content configuration; and
generate content commands based on the content configuration and the composition object, wherein
the composition object defines a layout of entities within game scenes of the game application.

8. The computing system of claim 7, wherein the composition object is appended to the content configuration.

9. The computing system of claim 1, wherein the game type is one of at least a survival game or an A-to-B game.

10. The computing system of claim 1, wherein the processing circuitry is configured to further generate a natural language response inviting a subsequent user input to modify the game application.

11. A computing method for generating a game application via a modular game maker model, the computing method comprising:
receiving a user input;
determining a game type based on the user input;
generating a content configuration based on the user input and the game type;
generating content commands based on the content configuration; and
generating the game application by executing the content commands to select and interconnect modular a set of subgraphs from a library of a plurality of subgraphs via visual scripting logic.

12. The computing method of claim 11, wherein the content configuration is generated by generating one or more prompts, inputting the one or more prompts into a language model to generate one or more responses, and consolidating the one or more responses from the language model into the content configuration.

13. The computing method of claim 11, wherein the content configuration defines at least one of game type, win conditions, loss conditions, main entities, or secondary entities.

14. The computing method of claim 11, wherein each modular subgraph represents a function or behavior within the game application.

15. The computing method of claim 14, wherein the subgraphs include at least one of an effect state, a player movement controller, a trigger, an animation, a collision manager, a user interface (UI) visual, a win manager, or a lose manager.

16. The computing method of claim 11, further comprising:
generating a composition object based on the content configuration; and
generating content commands based on the content configuration and the composition object, wherein
the composition object defines a layout of entities within game scenes of the game application.

17. The computing method of claim 16, wherein the composition object is appended to the content configuration.

18. The computing method of claim 11, wherein the game type is one of at least a survival game or an A-to-B game.

19. The computing method of claim 11, further comprising generating a natural language response inviting a subsequent user input to modify the game application.

20. A computing system for generating a game application, the computing system comprising:
processing circuitry and memory storing instructions that, when executed, cause the processing circuitry to:
receive a user input;
generate content commands based on the user; and
execute the content commands to generate the game application by selecting and interconnecting a set of subgraphs from a library of a plurality of subgraphs via visual scripting logic, wherein
the subgraphs include at least one of an effect state, a player movement controller, a trigger, an animation, a collision manager, a UI visual, a win manager, or a lose manager.
